(19) United States
(12) Patent Application Publication
(10) Pub. No.: US 2025/0106208 A1
(43) Pub. Date: Mar. 27, 2025

(54) ESTABLISHING TRUST FOR AN API CALL FROM A CLIENT TO A TARGET SERVICE USING A RELAY GATEWAY

(71) Applicant: SKYFLOW INC, Los Altos, CA (US)

(72) Inventor: Daniel ManHung Wong, Palo Alto, CA (US)

(21) Appl. No.: 18/475,453

(22) Filed: Sep. 27, 2023

(51) Int. Cl. H04L 9/40

(52) U.S. Cl. CPC H04L 63/0876; H04L 63/0807; H04L 63/102

(57) ABSTRACT

Trust is established using a relay gateway for an API call from a client to a target service. In an example, an API call is received at a relay gateway from a client and directed to a target service. The API call includes a credential that is not for the relay gateway. The API call is authenticated using the credential. The API call is forwarded to the target service in response to the authentication. An API response is received from the target service and forwarded from the relay gateway to the client.

### FIELD

The disclosure relates to establishing trust between a client and a relay gateway, and more particularly, to establishing trust for an API (Application Programming Interface) call from the client to a target service through the relay gateway.

### BACKGROUND

Internet services may be provided by cloud services and use APIs to allow a user device or client to access the cloud services. APIs provide an interface from one software application to another software application to perform an action and are particularly common for web applications. API calls are used for browsing the Internet, posting content, consuming content, and other actions.

With an API implementation, a user or client and the user's device are first authenticated to an API target service. The user device receives credentials from the API target service and stores the credentials locally. When the user later makes an API call from the user's device, it sends the API to the API target service in response to the authentication. The API target service validates the credentials and then uses the API call as a service provider to invoke an API service on behalf of the user. The API target service may directly respond to the API call or invoke other or additional resources to service the API call. The API target service may perform various actions at the API target service or other cloud services. Often a response or a confirmation is sent back to the user device. The user may continue with additional API calls and may receive more responses from the target service.

To improve Internet security, the API call is not serviced without valid credentials from the user device. The user device configures the appropriate credentials with each API service and then stores, maintains, updates, and tracks the credential for each of the different API services. Security is improved when different credentials are used with different service providers.

API services may be provided through a relay gateway between the client and the target service. The client establishes credentials also with the relay gateway to send API calls through the relay gateway to the target service.

### BRIEF DESCRIPTION OF THE DRAWING FIGURES

The invention may best be understood by referring to the following description and accompanying drawings that are used to illustrate embodiments of the invention. In the drawings:

FIG. 1 is a block diagram of components to service an API call according to embodiments of the invention;

FIG. 2 is a second block diagram of components to service an API call according to embodiments of the invention;

FIG. 3 is a process flow diagram of a method of servicing an API call according to embodiments of the invention;

FIG. 4 is a signaling diagram of accessing a target service using a relay gateway according to embodiments of the invention;

FIG. 5 is a second process flow diagram of a method of servicing an API call according to embodiments of the invention;

FIG. 6 is a second signaling diagram of accessing a target service using a relay gateway according to embodiments of the invention; and

FIG. 7 is a block diagram of a computer system representing an example of a system upon which features of the described embodiments may be implemented.

### DETAILED DESCRIPTION

Many services require that an API call must be authenticated and authorized before it may be serviced. The presentation of credentials from the client may be part of invoking an API service. When a client, used herein to refer to a device operated by a user, e.g., a remote terminal, a portable device, a local node, etc., makes an API call without the expected credentials, then the call will be ignored or rejected. The API credentials are typically arranged in advance between the API service and the client for that service. When an API service provider cannot arrange the credentials with the client in advance, then the API call from the client to invoke the API service fails.

Similarly, when the API call is through a relay gateway, the client and the API call must be authenticated and authorized before the API call is passed from the relay gateway to the API service. There are many different reasons that a client may not have the credentials. In some circumstances the client does not have access to procure an API credential. In some circumstances the client does not want to arrange, maintain, and track a set of API credentials for the API service. In some circumstances the service provider does not want to expose the entity that is actually performing the service for the client. In some instances, this may be for a white label service in which the arrangement between service providers is confidential.

In an example, an API call is received at a relay gateway from a client and directed to a target service. The API call includes a credential that is not for the relay gateway. The API call is authenticated using the credential. The API call is forwarded to the target service in response to the authentication. An API response is received from the target service and forwarded from the relay gateway to the client. In some circumstances the target service may trust API calls from the relay gateway on the basis that the relay gateway may be trusted to have performed sufficient security verifications. An API response is received from the target service and forwarded from the relay gateway to the client.

The credential that is received with the API call may be a credential from the target service to the client, from an identity service to the client, or from any other service to the client. The credential does not evidence or indicate a trust relationship between the client and the relay gateway but between the client and some other service. The credential, as referred to herein, may also include characteristics of the call including an IP address, account credentials, factors such as time of day and parameters of a payload, etc.

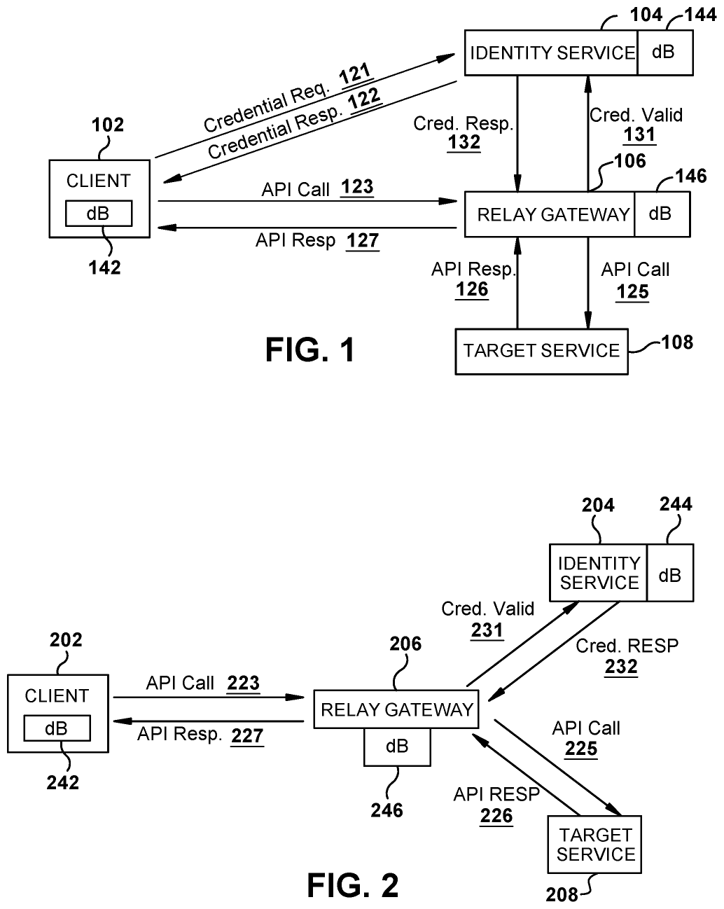

Referring to FIG. 1, in many scenarios a relay gateway 106 is coupled between a client 102 and a target service 108. The relay gateway connects the client, or a network that includes the client, to the target service or to a network that includes the target service. The relay gateway may convert protocols, encapsulate and decapsulate packets for transmission through a physical layer of a network, and direct traffic through appropriate routes, channels, or paths. The relay gateway may be a part of a router, switch, or another network device. The communication may be through any suitable type of network connection using e.g., HTTP (Hypertext Transfer Protocol) and TLS (Transport Layer Security) sessions.

The relay gateway may be an API gateway that acts as a point-of-entry for requests for application services sent by end-user applications at the client. Instead of sending the API calls directly to individual target services, the API calls go through the gateway. API calls that receive authorized access from the gateway are then directed to a range of services, e.g., application microservices, user-access authentication, security policy enforcement, load balancing, cache management, dependency resolution, Service Level Agreement management, etc.

The relay gateway may provide any of a variety of different components to assist with the connection between the client and the target service. An Access Control component manages which API calls can connect to each application service and the rules for how data requests are handled. Only authenticated user applications from the client are connected to a respective target service. A Threat Detection component protects against malicious actors that attempt to upload malware, inject SQL (Structured Query Language) instructions, launch DDOS (Distributed Denial-of-Service) attacks, etc. A Protocol Translation component translates REST (Representational State Transfer) protocol calls into SOAP (Service Object Access Protocol) format, etc. Additional components may perform rate limiting, auto-scaling, monitoring, and disaster recovery.

API calls may be authenticated as appropriate to the nature of the API call. With a common HTTPS (Hyper Text Transport Protocol Secure) Basic Authentication, a username and password are sent alongside the API call. API Key Authentication provides for unique keys that are passed with each API call. OAuth Authentication allows a third party to provide keys and authenticate approvals for allowed API call. Token Validation provides for a token to be sent with the API call that is used to authenticate the client, such as a bearer token. In some embodiments, OpenID Connect or a similar tool may be used as an identity layer on top of an authorization protocol. An ID token is sent with each API call. SAML (Security Assertion Markup Language) provides security assertion using a markup language. All of these authentication techniques have vulnerabilities.

Security vulnerabilities may arise when the client does not have credentials for the relay gateway. A relay gateway may allow the client to invoke an API without presenting the credentials of the relay gateway. Instead, the relay gateway forwards the API call, along with credentials from the target service or from a different API service provider, e.g., identity service 104, to the downstream API application service 108. The downstream API application service then handles the authentication and authorization. However, in some cases, the downstream API application 108 may not have sufficient information to authenticate and authorize the credentials from the other API service provider 104. Another security implication occurs when the relay gateway 106 does not apply any basic authentication or authorization security validation before it processes the API calls and forwards them. This makes the relay gateway vulnerable to unauthenticated user attacks. The relay gateway is then not suitable for performing any non-public operations such as handling sensitive data.

In embodiments described herein a relay service, e.g., a relay gateway 106, makes an authentication and authorization decision based on factors that are used to characterize the client 102. These factors may be defined by a relay gateway administrator or by an API service provider 108. The factors may include an IP address of the client, the time of day, or specific parameters of the payload. The relay service 106 may also impersonate the client 102 to the target service provider 108 based on other credentials received from the client 102. The relay service may also verify the client as having an account using a safe API such as a login API.

In embodiments described herein the relay gateway 106 may rely on trust that has already been established between another API service provider 104 and the client 102. In such a scenario, the other API service provider is serving as an identity service. This allows the credentials with the identity service to be used to authenticate the client 102 to the relay gateway 106. The relay gateway may be configured to trust the credentials of particular identity services. The trust may be limited to particular users and particular types of API calls. In some embodiments, an API key or another credential based on a shared secret may be used. The shared secret may be a secret known only to the client and the identity service. The secret may be trusted by the relay gateway or the secret may be validated by the relay gateway with the identity service before it is trusted by the relay gateway.

In some embodiments, a token or other signature-based validation scheme may be used. The validation may be done with a public certificate, which can be obtained from the client. The token or ticket may contain identities asserted by the client and may be used by the target service to map to a local identity.

The relay gateway may perform additional validation operations. Certain characteristics of the client may be known to the relay gateway, through observation, a tracking history, or reports from the client. The characteristics may be stored in a suitable memory 146 for the respective client and associated with a user ID (Identifier), account ID, IP (Internet Protocol) address, or other identification data. The characteristics may include the client's IP address, a time of day, and others. The relay gateway may compare the current characteristics of a received API call 123 from the client to these characteristics.

In some embodiments the client's token has the format of a JavaScript Object Notation (JSON) Web Token (JWT). A JWT is a JSON object with a header, payload, and signature used to securely transfer information over network connections between the two parties. It is used for authentication and can also be used for information exchange. The token may include a key and an identification of the identity service.

Once the identity info is obtained from the client. The relay gateway will map the API call to an established identity of the relay gateway for the client that is also stored in a local access management system 146 in association with a client identifier. The established identity may vary based on the configuration of the API call. The API call will be treated as being from an authenticated entity, the client. All further authorization and processing of API calls during the same session or within a time period may be based on that mapped identity.

FIG. 1 is a diagram of components to service an API call from a client 102 to a target service 108. Many more components may be present in the network, including intermediate switches and routers. A client 102 is coupled to the relay gateway 106 through a network, e.g., a local area network (LAN), metropolitan area network (MAN), wide area network (WAN), or any other network. The client 102 is also coupled to the identity service 104 through a network, which may be the same or a different network. The client sends a credential request 121 to the identity service 104. The request may be in the form of an API call or in another suitable form. The identity service may be configured for identity services or may be a more capable API service provider. The identity service may request various types of information and proofs from the client. In one embodiment, the identity service establishes trust using a user name and password. In other embodiments, multiple level authentications, biometrics, third party validation, or other tools may be used. After a trust relationship is established between the client and the identity service, the identity service sends 122 a credential to the client. The client stores the credential in a local database 142.

The client desires to invoke an API call with a target service 108. Instead of contacting the target service 108 directly, the client sends an API call 123 to the relay gateway 106. The relay gateway 106 is coupled to the target service through a network. The relay gateway 106 receives 123 the API call from the client directed to the target service. The API call includes the client credential from the identity service 104 and a client identification. The client retrieves the credential from its local database 142. The client identification may take different forms, e.g., an IP (Internet Protocol) address, a session identifier, a user name, etc. The relay gateway tests the credential in order to validate the credential. In some examples the relay gateway tests the credential by sending a validation request 131 to the identity service 104. The identity service compares the credentials to a database 144 of established identities. If the credentials are valid credentials with the identity service, then a credential response 132 will be positive. Otherwise, the credential response will be negative. If the credential is validated, then the relay gateway forwards 125 the API call to the target service in response to the authentication.

The relay gateway 106, in some embodiments, does not have a trust relationship with the client 102. The target service 108 may have a trust relationship with the client 102 that is evidenced by a credential established between the identity service and the client or between the target service and the client. The credential established between the identity service and the client does not evidence a trust relationship with the relay gateway. Accordingly, the relay gateway may trust the credential from the identity service or the credential from the identity service may be tested or validated by the relay gateway. The target service 108 services the API call, generates an API response and returns 126 the API response to the relay gateway 106. The relay gateway forwards 127 the API response to the client 102.

In some embodiments, the credential that was received from the client is not sent from the relay gateway to the target service. For such embodiments, the target service 108 has a trust relationship with the relay gateway so that a credential from the relay gateway is sufficient for the target service 108 to service the API call. The client 102 may also have a credential from the relay gateway stored in its local database 142. In another example a credential from the relay gateway is not needed, if a secure message is sent from the relay gateway to the target service with the API call. In response to the API call forwarded by the trusted relay gateway, the target service generates an API response and the relay gateway receives the API response from the target service. The API response is returned 126 to the relay gateway and is forwarded 127 from the relay gateway to the client 102. Additional API calls may be sent from the client and serviced by the target service through the relay gateway.

FIG. 2 is an alternative diagram of components to service an API call from a client to a target service. Many more components may be present in the network, including intermediate switches and routers. A client 202 is coupled to a relay gateway 206. All of the traffic with the identity service and with the target service is sent through the relay gateway 206. The client 202 is coupled to the relay gateway 206 through one network and the relay gateway is coupled to an identity service 204 and a target service 208 through one or more other networks. The client optionally obtains credentials from an identity service 204 by sending a request to the identity service through the relay gateway 206. The identity service 204 sends credentials back to the client 202 through the relay gateway 206. The credentials are stored in a database 242 at the client. The database may include credentials with other service providers including with the relay gateway.

When the client seeks to invoke an API call at a target service 208, the client 202 sends 223 a request through the relay gateway 206 to the target service. The relay gateway validates the credentials of the client. The relay gateway has a database 246 with clients and associated credentials or other validation information. In some embodiments, the relay gateway sends 231 a credential validation request to the identity service 204. In this example, the identity service generated the original credentials and is able to validate the credential using data stored in its own database 244 and sends 232 a credential response back to the relay gateway. In some embodiments, a second service is associated with the identity service and is able to validate credentials generated by or for the identity service. The relay gateway may also use other information in its database 246 to validate the client for the API call that it received 223 from the client.

After the client is validated with the relay gateway for the received 223 API call, the relay gateway sends 225 a validation with the API call to the target service. The target service generates a response to the API call and sends 226 the response back to the client through the relay gateway. The relay gateway forwards 227 the response back to the client.

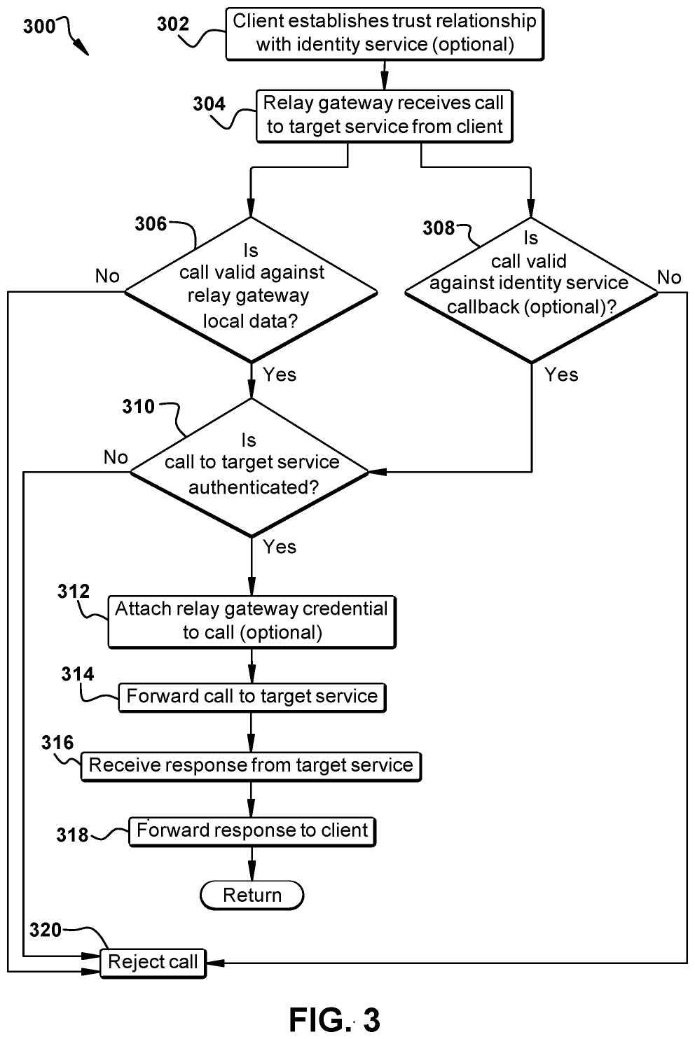

FIG. 3 is a process flow diagram of operations at the relay gateway for invoking an API call at a target service. The process optionally begins at 302 when the client establishes a trust relationship, including credentials, with an identity service. The credentials may be API credentials, a token, or another form of credential. The identity service may be configured specifically for establishing trust with clients on behalf of other services, or it may be a part of a service that provides many other services. The process described herein is particularly well-suited for cloud services. In some examples the client establishes a secure tunnel to the relay gateway and the relay gateway provides secure access to many different services including the example services described here. The secure access may be in the form of a virtual private network, or any other suitable form.

The trust relationship between the client and the identity service may be established in any suitable way. After the identity service trusts the client, then it sends a credential to the client. The client uses this credential with subsequent interactions with the identity service to prove the trust relationship. The client saves the received credential in a memory or database that allows the client to retrieve the credential and provide it to the identity service when the client sends an API call or other request to the identity service. The client may maintain a table of credentials with different services so that it may authenticate its trust relationship with different services.

The credential may take different forms to suit the security, portability, protocol, and control needs of the identity service. The credential can be in the form of a username and password combination, a JWT token, a bearer token, a Kerberos ticket, or any other credential format. The credential may include encryption keys, certificates, and other components. The credential identifies the identity service that provided the credential and also the client.

In some embodiments, the credential is in the form of a JWT, or other signature-based scheme. The client may obtain a public certificate to support the token and the client may then generate a JWT that contains identities and tokens to map to a local identity that is trusted by the identity service.

The client sends a call, e.g., an API call, to the relay gateway. The call is to a target service. However, instead of using a credential of the target service to show a trust relationship with the target service, the client optionally includes the credential from the identity service. The credential shows the trust relationship with the identity service but has no connection to the target service. In addition, the credential is not issued by the relay gateway and does not show a trust relationship with the relay gateway. The relay gateway receives this call to the target service from the client at 304.

Upon receiving the call, the relay gateway validates the call to the target service before forwarding the call. The client may be validated based on characteristics of the call, such as header information, parameters of the payload, or identifying information in the call, either in the packet structure or in the credential. This information can be compared against local data stored at the relay gateway. The relay gateway can determine whether the call is valid against local data at 306. In some examples the relay gateway parses the call to extract information about the call. The API call will be in the form of a packet suitable for transport on the network that connects the relay gateway and the client, such as Ethernet, TCP (Transmission Control Protocol), ICMP (Internet Control Message Protocol) or other suitable form. Such a packet includes a time of day, an IP address of the source, in this case the client, a source address, and other information about the client, including the credential with the identity service. There may also be credentials that the client has with other services, but that the relay gateway has previously stored that can be used to validate the client. The relay gateway compares this to characteristics of the call that are stored at the relay gateway in association with the client to ensure that there is a match and that the package has actually come from the client. If the call is valid against relay gateway local data, then the process goes to 310. If the call is not valid, then it is rejected at 320.

For a validation based on the identity service credentials at 308, the relay gateway checks with data stored in its local database or optionally sends the identity service credentials to the identity service with a request to validate the credentials. In some embodiments, this is a callback to the identity service. The identity service will test the credentials and if they are valid credentials from the identity service, then the identity service sends a response to the relay gateway validating the credential. The relay gateway in this instance is able to leverage the identity service credential against the identity service to validate the identity service's credential with the client. In some circumstances when the relay gateway sends a callback function to the identity service, the identity service may require confirmation from the client. The client then sends identify information such as a public key or token to the identity service in response to the callback function.

In some embodiments, the relay gateway uses the credentials received from the client to impersonate the client and check to determine whether the credentials are valid. As an example, the relay gateway may use a user name and password from the credentials to determine whether the relay gateway can successfully log on to the identity service as if it were the client. If so, then the credentials are trusted.

In some embodiments, the relay gateway is able to validate the identity service credentials without sending a callback to the identity service. In some embodiments, the relay gateway validates the identity service credentials using the JWT received from the client and a public key obtained separately. The relay gateway is able to trust the credentials from the identity service that were received from the client. If the call is valid against the identity service callback, then the process goes to 310. If the call is not valid, then it is rejected at 320.

At 310, the relay gateway takes the results from the different validation processes and determines whether to trust the call. If the call is valid then it is authenticated and authorized. The client may have certain restrictions or limitations regarding the types of calls that it can make to the particular target service that it is trying to reach. The credential may also include restrictions and limitations about what the client may be permitted to do. If the call cannot be validated with one or both tests 306, 308, then the call is rejected at 320.

The call from the client may then be prepared to send to the identity service. When a JWT is used as the credential, the token includes a principal identifier. This principal identifier may be used as a pre-arranged attribute with the target service. At 312 the relay gateway optionally attaches a relay gateway credential to the call. This credential may be one of multiple credentials that the relay gateway has established with the target service. The credentials may be used with different clients at different times. Once the client's identity information is obtained, the client's identity information is mapped to an already established identity of the relay gateway. Further authorization and processing at the relay gateway will be based on the client's identity that was mapped earlier.

At 314 the relay gateway forwards the call to the target service with the client's credentials, with the relay gateway's credentials, or with no credentials, depending on the nature of the call and the requirements of the target service to service the call. The authentication and authorization established by the relay gateway may be used to enable security sensitive operations by the target service with the client.

At 316 the relay gateway receives a response from the target service. In some embodiments, the response is directed to the client. In some embodiments, the response is directed to the mapped relay gateway identity. At 318 the response is forwarded to the client. The process returns so that the client may proceed to send further calls that are received at the relay gateway and processed as described above.

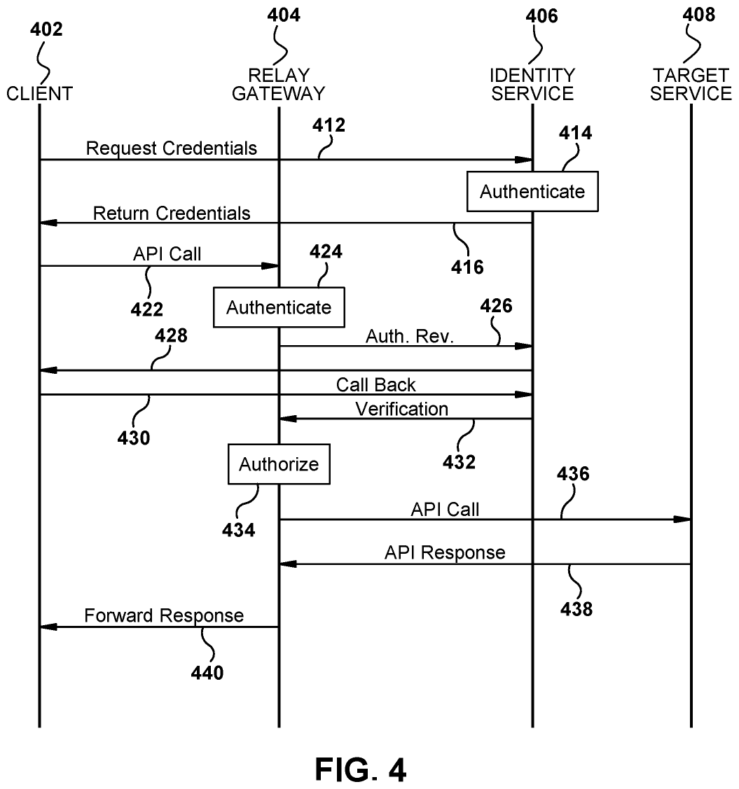

FIG. 4 is a signaling diagram of authenticating an API call for application to a target service. A client 402 is in direct or indirect communication with a relay gateway, 404, an identity service 406 and target service 408. The client 402 optionally authenticates with the identity service 406 by sending a request for credentials with signal 412. The connection between the client and the authentication utility may be secured through a closed device or network of devices or using a secure connection, for example a VPN, HTTPS, or any other secure communications format. The identity service 406 authenticates the client at 414. This may include various authentication and verification tests or third party or second channel proofs. The identity service 406 generates credentials if the client is authenticated and sends the credentials back to the client with signal 416.

At a later time, the client 402 sends an API call 422 to a target service 408 through a relay gateway 404. The relay gateway receives the API call 422 and authenticates it 424 in one or more different ways. In one example, the API call includes the credentials received from the identity service 406 and the relay gateway tests these credentials by requesting 426 an authentication from the identity service 406. The identity service may respond directly with a positive or negative verification 432 back to the relay gateway. The identity service may also send a callback 428 to the client. If the client successfully responds 430 to the callback 428, then the authentication has been verified, at least in part. The identity service may perform other tests to verify the client.

Upon receiving the verification 432 from the identity service or upon performing other authentication tests, or both, the relay gateway authenticates the client and the API call as coming from the client. The relay gateway may then authorize 434 the client for some or all privileges for API calls to the target service 408. The relay gateway then forwards 436 the API call to the target service.

The target service may rely on the relay gateway to authenticate and authorize the client for the particular API call. The target service 408 then executes the API call 436 and generates a response 438 to the relay gateway, which forwards 440 the API response 438 to the client 402. In some embodiments the client may continue to send API calls and other requests to the target service and to other target services through the relay gateway.

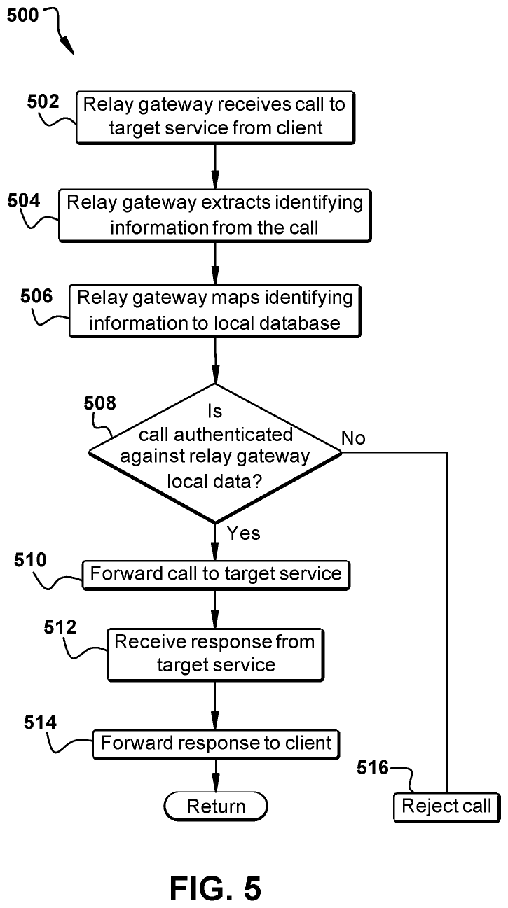

FIG. 5 is a second process flow diagram of operations at the relay gateway for invoking an API call at a target service. The process begins at 502 when the relay gateway receives an API call to a target service from a client. The client sends the call, e.g., an API call, to the relay gateway. The call includes a credential and is directed to a target service, e.g., an API service. However, the credential is not issued by the relay gateway. The credential may or may not show a trust relationship an identity service or the target service.

Upon receiving the call, the relay gateway extracts identifying information about the client from the call at 504. The identifying information may be in the included credential or in other aspects of the received API call, e.g., a source IP address, time of day, parameters of the payload, etc. The extracted information may be mapped to information stored in the local database of the relay gateway at 506. This allows the relay gateway to determine if the client is known and can be authenticated. In some examples the credential is issued by another service and the relay gateway has information about the credential in its local database so that it can authenticate the call using a credential previously issued by a different authority.

At 508, if the API call is authenticated against the relay gateway local data at 508, then at 510 the call can be forwarded to the target service. If the API call is not authenticated at 508, then at 516, it is rejected.

The call from the client may then be prepared to send to the identity service. When a JWT is used as the credential, the token includes a principal identifier. This principal identifier may be used as a pre-arranged attribute with the target service. The relay gateway may also attach a relay gateway credential to the call. This credential may be one of multiple credentials that the relay gateway has established with the target service but not with the client. The credentials may be used with different clients at different times. In this example, once the client's identity information is obtained, the client's identity information is mapped to an already established identity of the relay gateway. Further authorization and processing at the relay gateway will be based on the client's identity that was mapped earlier.

At 510 the relay gateway forwards the call to the target service with the client's credentials, with the relay gateway's credentials, or with no credentials, depending on the nature of the call and the requirements of the target service to service the call. The authentication and authorization established by the relay gateway may be used to enable security sensitive operations by the target service with the client.

At 512 the relay gateway receives a response from the target service. In some embodiments, the response is directed to the client. In some embodiments, the response is directed to the mapped relay gateway identity. At 514 the response is forwarded to the client. The process then returns and the client may proceed to send further calls that are received at the relay gateway and processed as described above.

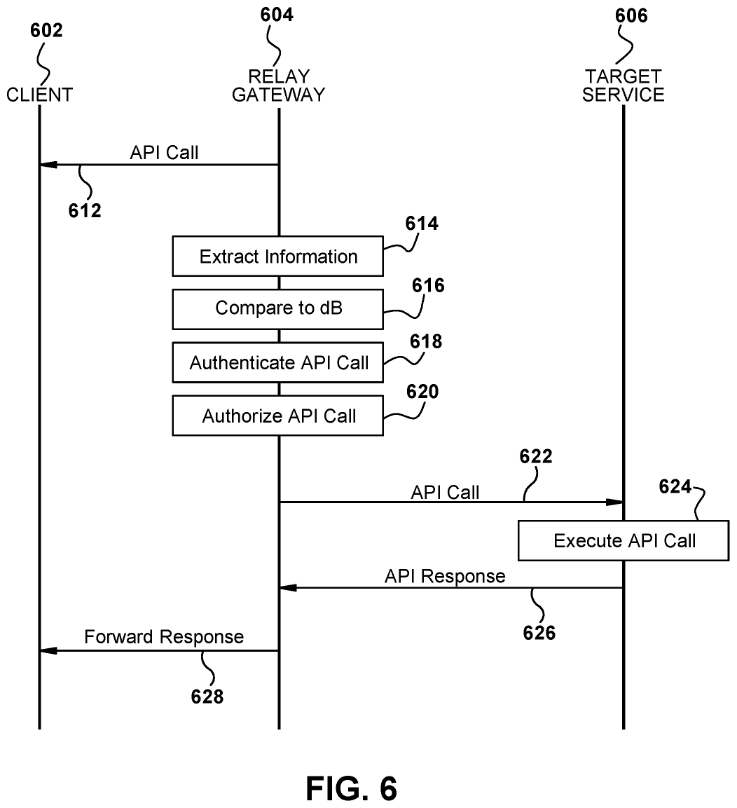

FIG. 6 is a signaling diagram of authenticating an API call for application to a target service. A client 602 is in indirect communication with a target service 606 through a relay gateway 604. The client 602 sends an API call 612 to the target service 606 through the relay gateway 604. The relay gateway receives the API call 612 and authenticates it. In this example, the relay gateway extracts information 614 from the API call. The relay gateway compares 616 at least a portion of the information in the call to information stored in a local database. The relay gateway authenticates 618 the API call and also authorizes 620 the API call in response to the comparison to its local database.

In response to authenticating and authorizing the API call, the relay gateway then forwards 622 the API call to the target service 606. The target service may rely on the relay gateway to authenticate and authorize the client for the particular API call. The target service 606 then executes the API call 624 and generates a response 626 to the relay gateway, which forwards 628 the API response 626 to the client 602. In some embodiments the client may continue to send API calls and other requests to the target service and to other target services through the relay gateway.

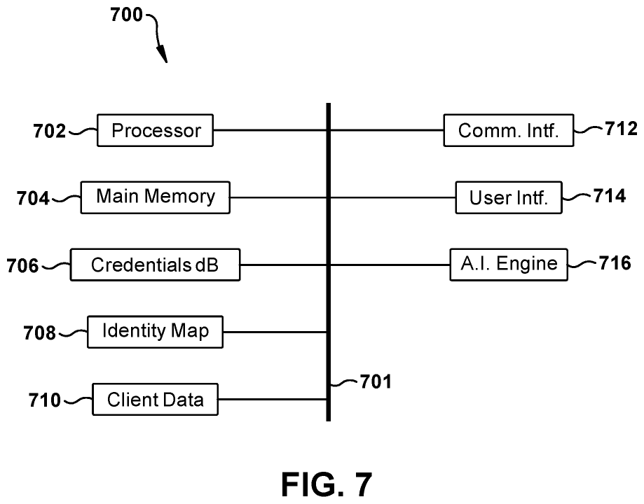

FIG. 7 is a block diagram of a computer system 700 representing an example of a system upon which features of the described embodiments may be implemented, such as the client, relay gateway, identity service and target service. In the case of cloud services, one or more of the components may be virtualized. The computer system includes a bus or other communication means 701 for communicating information, and a processing means such as one or more microprocessors 702 coupled with the bus for processing information. A main memory 704 such as a solid-state disk, magnetic disk, disk array, or optical disc and its corresponding drive may also be coupled to the bus of the computer system for storing information and instructions. For purposes of the present description, the main memory may include various memory devices such as a random-access memory (RAM), or other dynamic data storage device, a nonvolatile memory such as a read only memory (ROM) or other static data storage device coupled to the bus for storing information and instructions to be executed by the processor. The main memory also may be used for storing temporary variables or other intermediate information during execution of instructions by the processor.

As part of the main memory 704 or as discrete memory in internal or external components, the system further includes a credentials database 706, an identity map 708, and client data 710. The credentials database may store credentials received from clients, including credentials with a relay gateway, credentials from an identity service, and credentials from a target service. The identity map may include a map of client identities to relay gateway identities or client identities to identity service identities. Such a map may be used to send API calls to other components using an alias or alternative identity and to track the association of the two mapped identities. The client data may be used to record history and identification information of clients and other components that may be used for verification, authentication, and authorization. Such client data may also be used to compare a received API call to the client data. This allows the system to verify IP addresses, hours of operation, previously received credentials, etc.

A communications interface 712 is also coupled to the bus. The communications interface may include a wired or wireless modem, a network interface card, or other well-known interface devices, such as those used for coupling to Ethernet, token ring, cellular telephony, Wi-Fi, or other types of physical attachment for purposes of providing a communication link to support a local or wide area network (LAN or WAN), for example. In this manner, the computer system may also be coupled to a number of clients or servers or to virtual network resources via one or more conventional network infrastructures, including an intranet or the Internet, for example.

The computer system can also be coupled via the bus to a user interface 714 which may be a remote access interface of a headless device. Alternatively, the user interface may include a display device or monitor for displaying information to a user or administrator, for example, graphical and textual indications of installation status, operations status, schema configurations, and other information may be presented to the user on the display device. Typically, an alphanumeric input device such as a keyboard with alphanumeric, function and other keys, may be coupled to the bus for communicating information and command selections to the processor. A cursor control input device such as a mouse, a trackball, trackpad, or cursor direction keys can be coupled to the bus for communicating direction information and command selections to the processor and to control cursor movement on the display.

The system of FIG. 7 further includes an AI (Artificial Intelligence) engine 716. This may be implemented in dedicated hardware using parallel processing or in the processor 702 or using some combination of resources. The AI engine may also be external to the computer system 700 and connected through a network node or some other means. The AI engine may be configured to use historical data accumulated by the computer system or another system to build a model that includes weights and criteria to apply to the selection processes, operations, and encryption among others. The model may be repeatedly rebuilt using the accumulated data to refine and increase accuracy.

A lesser or more equipped computer system than the example described above may be preferred for certain implementations. Therefore, the configuration of the exemplary computer system will vary from implementation to implementation depending upon numerous factors, such as price constraints, performance requirements, technological improvements, or other circumstances. The computer system may be duplicated in different locations for distributed computing. As an example, the system may use a simple pre-programmed deterministic selection model instead of an AI model and the AI engine.

While the steps described herein may be performed under the control of a programmed processor, in alternative embodiments, the steps may be fully or partially implemented by any programmable or hard coded logic, such as Field Programmable Gate Arrays (FPGAs), Transistor-Transistor Logic (TTL), or Application Specific Integrated Circuits (ASICs), for example. Additionally, the methods described herein may be performed by any combination of programmed general purpose computer components or custom hardware components. Therefore, nothing disclosed herein should be construed as limiting the present invention to a particular embodiment wherein the recited steps are performed by a specific combination of hardware components.

In the present description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. The specific detail may be supplied by one of average skill in the art as appropriate for any particular implementation.

The present description includes various steps, which may be performed by hardware components or may be embodied in machine-readable instructions, such as software or firmware instructions that are stored on a machine-readable medium, such as a memory or storage device. The machine-readable instructions may be used to cause a general-purpose or special-purpose processor programmed with the instructions to perform the steps. Alternatively, the steps may be performed by a combination of hardware and software.

The described operations may be provided as a computer program product that may include a machine-readable medium having stored instructions thereon, which may be used to program a computer (or other machine) to perform a process according to the present invention. The machine-readable medium may include, but is not limited to optical disks, CD-ROMs, and magneto-optical disks, ROMs, RAMs, EPROMs, EEPROMs, magnet or optical cards, flash memory, or any other type of medium suitable for storing electronic instructions. Moreover, the present invention may also be downloaded as a computer program product, wherein the program may be transferred from a remote computer to a requesting computer by way of data signals embodied in a carrier wave or other machine-readable propagation medium via a communication link (e.g., a modem or network connection).

Although this disclosure describes some embodiments in detail, it is to be understood that the invention is not limited to the precise embodiments described. The specification and drawings are, accordingly, to be regarded in an illustrative rather than a restrictive sense. Various adaptations, modifications and alterations may be practiced within the scope of the invention defined by the appended claims.

Example implementations as described above are set forth in summary form below:

A method comprising receiving an API call at a relay gateway from a client and directed to a target service, the API call including a credential that is not for the relay gateway, authenticating the API call using the credential, forwarding the API call to the target service in response to the authentication, receiving an API response from the target service, and forwarding the API response from the relay gateway to the client.

A method as described above wherein authenticating the API call comprises comparing characteristics of the API call to stored characteristics.

A method as described above wherein the characteristics include an IP address of the client.

A method as described above wherein the characteristics include account credentials of the client.

A method as described above wherein authenticating the API call comprises comparing factors of the client to known factors of the client.

A method as described above wherein the factors comprise time of day and parameters of a payload of the API call.

A method as described above further comprising retrieving a relay gateway credential with the target service and wherein forwarding the API call comprises forwarding the API call with the relay gateway credential.

A method as described above wherein the relay gateway has a plurality of credentials that are validated with the target service and wherein forwarding the API call comprises forwarding the API call to the target service with a relay gateway credential as an authentication to the target service.

A method as described above wherein receiving the API call comprises receiving the API call with a client credential from an identity service; and authenticating the API call comprises validating the client credential at the relay gateway.

A method as described above wherein the client credential is from an identity service that is not the target service.

A method as described above wherein the identity service is an API service provider.

A method as described above wherein the identity service is an API identity service associated with the target service.

A method as described above wherein validating the client credential comprises receiving a validation of the client credential from the identity service.

A method as described above wherein receiving a validation comprises receiving the validation is in response to sending a callback function to the identity service.

A method as described above wherein the identity service receives identity information from the client in response to the callback function before sending a response to the callback function to the relay gateway.

A method as described above wherein forwarding the API call comprises forwarding the API call with the client credential.

A method as described above wherein the client credential comprises a service ticket of a web token.

A method as described above wherein the service ticket contains identities of the client and wherein the relay gateway maps the identities to an identity of the relay gateway.

A relay gateway comprising means for receiving an API call at a relay gateway from a client and directed to a target service, the API call including a credential that is not for the relay gateway, means for authenticating the API call using the credential, means for forwarding the API call to the target service in response to the authentication, means for receiving an API response from the target service, and means for forwarding the API response from the relay gateway to the client.

A relay gateway comprising a communications interface to receive an API call at a relay gateway from a client and directed to a target service, the API call including a credential that is not for the relay gateway, and a credentials database to authenticate the API call using the credential at the relay gateway, the communications interface further to forward the API call to the target service in response to the authentication, to receive an API response from the target service, and to forward the API response from the relay gateway to the client.

What is claimed is:

1. A method comprising:
receiving an API call at a relay gateway from a client and directed to a target service, the API call including a credential that is not for the relay gateway;
authenticating the API call using the credential;
forwarding the API call to the target service in response to the authentication;
receiving an API response from the target service; and
forwarding the API response from the relay gateway to the client.

2. The method of claim 1, wherein authenticating the API call comprises comparing characteristics of the API call to stored characteristics.

3. The method of claim 2, wherein the characteristics include an IP address of the client.

4. The method of claim 2, wherein the characteristics include account credentials of the client.

5. The method of claim 1, wherein authenticating the API call comprises comparing factors of the client to known factors of the client.

6. The method of claim 5, wherein the factors comprise time of day and parameters of a payload of the API call.

7. The method of claim 1, further comprising retrieving a relay gateway credential with the target service and wherein forwarding the API call comprises forwarding the API call with the relay gateway credential.

8. The method of claim 1, wherein the relay gateway has a plurality of credentials that are validated with the target service and wherein forwarding the API call comprises forwarding the API call to the target service with a relay gateway credential as an authentication to the target service.

9. The method of claim 1 wherein:
receiving the API call comprises receiving the API call with a client credential from an identity service; and
authenticating the API call comprises validating the client credential at the relay gateway.

10. The method of claim 9, wherein the client credential is from an identity service that is not the target service.

11. The method of claim 10, wherein the identity service is an API service provider.

12. The method of claim 10, wherein the identity service is an API identity service associated with the target service.

13. The method of claim 9, wherein validating the client credential comprises receiving a validation of the client credential from the identity service.

14. The method of claim 13, wherein receiving a validation comprises receiving the validation is in response to sending a callback function to the identity service.

15. The method of claim 14, wherein the identity service receives identity information from the client in response to the callback function before sending a response to the callback function to the relay gateway.

16. The method of claim 9, wherein forwarding the API call comprises forwarding the API call with the client credential.

17. The method of claim 9, wherein the client credential comprises a service ticket of a web token.

18. The method of claim 17, wherein the service ticket contains identities of the client and wherein the relay gateway maps the identities to an identity of the relay gateway.

19. A relay gateway comprising:
means for receiving an API call at a relay gateway from a client and directed to a target service, the API call including a credential that is not for the relay gateway;
means for authenticating the API call using the credential;
means for forwarding the API call to the target service in response to the authentication;
means for receiving an API response from the target service; and
means for forwarding the API response from the relay gateway to the client.

20. A relay gateway comprising:
a communications interface to receive an API call at a relay gateway from a client and directed to a target service, the API call including a credential that is not for the relay gateway; and
a credentials database to authenticate the API call using the credential at the relay gateway,
the communications interface further to forward the API call to the target service in response to the authentication, to receive an API response from the target service, and to forward the API response from the relay gateway to the client.
